(19) United States
(12) Patent Application Publication
(10) Pub. No.: US 2005/0136957 A1
(43) Pub. Date: Jun. 23, 2005

(54) Mobile connection broker

(76) Inventor: Tommi Raivisto, Vantaa (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/746,946

(22) Filed: Dec. 23, 2003

(51) Int. Cl. H04B 7/00

(52) U.S. Cl. 455/517

(57) ABSTRACT

A method and system are disclosed for setting up a communication session between a first peer inside a mobile network, and a second peer outside that mobile network. Contact is established from the second peer to a connection broker responsible for brokering various connections with the first peer, and the second peer requests from the connection broker a connection to the first peer. The connection broker determines whether the first peer is reachable, and finds out what costs, if any, would be borne by the first peer or the second peer or both, in order to pay for a lease of at least the connection requested by the second peer. Then the communication session is set up via the connection, if the first peer is reachable and the costs are acceptable.

### TECHNICAL FIELD OF THE INVENTION

The invention relates to communication between a peer located in a mobile network with another peer, the other peer being located in another network such as a fixed network utilizing the internet.

### BACKGROUND ART

Initiating session from a web domain, such as the internet, to a mobile domain has heretofore been difficult or impossible. This is mainly because operators of mobile networks typically charge the user for transmitted data. If the session is initiated from outside the mobile domain, then there has not been any convenient way to determine who to charge and how.

For example, a user may want his or her mobile device to host a web page or automatically provide other data or service to an internet user, but does not want to pay every time the internet user accesses the mobile device. There may also be cases where the user of the mobile device may want to pay even though the session is not initiated by her. These types of conundrums will become more common as mobile devices become more adept at providing web services without any need for the mobile device to be configured as full internet servers.

An additional problem with the current state of the art is that addressing terminals in a mobile network has been difficult, because mobile terminals are not always reachable and have no permanent internet protocol (IP) address. Furthermore, opening a mobile network for anyone to send data via a web site or other web service hosted by a mobile device would have certain difficult capacity and security implications: capacity of mobile networks per user is lower than that of fixed networks, and the nodes in mobile networks are typically not well-prepared against common external information security threats, such as internet viruses. These problems have not been adequately addressed by current methods of having peers in the mobile domain initiate all sessions that communicate across the boundary between mobile and web domains.

Application programming interfaces (APIs) are commonly used by applications (i.e. software programs) to initiate contact with network services, mainframe communications programs, telephone equipment, and program-to-program communications. When an application uses an API for this purpose, the API provides a set of standard software interrupts, calls, and data formats. Very frequently, APIs are used for peer-to-peer communication, meaning communication between two entities that operate within the same or virtually the same protocol layer of a system or set of systems. However, when a contact is received via an API, there often is no adequate way to negotiate whether or not the contact will succeed and who will pay for it, if anyone, especially when a wireless network is needed for the peer-to-peer communication.

An application that initiates a contact will often benefit from that contact, and therefore the recipient of the contact should be able to efficiently decide whether or not there will be a charge for the contact, and if so who should pay the charge. In the context of a mobile telecommunications system, in which an application outside the mobile network may wish to communicate with a peer inside the mobile network, for example to access a relational database or other resource in a mobile device, there currently is no effective way for this charging to occur in an efficient manner with costs appropriately apportioned.

### SUMMARY OF THE INVENTION

The present invention discloses a mechanism for a peer outside of a mobile network to initiate communication with a peer inside the mobile network. This communication between peers may consist of either a single transaction or it may be a session consisting of several transactions. This invention enables creation of applications outside a mobile network that can easily set up sessions with a peer inside the mobile network, while allowing the operator of the mobile network to control and charge for establishment of such sessions.

The present invention introduces a mobile connection broker that resides with any mobile network and enables acquisition of “virtual connections” from outside the mobile network to the peers inside the mobile network. The connection broker may be part of the fixed network, while having access to the mobile network, and hence the term “mobile connection broker.” The general concept of a connection broker is not new. See “Multi Tier Architectures for Database Connectivity” by Marc A. Mnich, Jan. 5, 1998 (available at www.javaexchange.com/deb_white.html). However, connection brokers have thus far not been developed to solve the problems described above as regards internet communication with a mobile network.

The connection broker acts similarly to a server with respect to third party applications. A peer outside the mobile network (e.g. communicating via internet) must acquire a “virtual connection” from the connection broker in order to be able to initiate a session with a peer inside the mobile network. This acquisition service may be provided by the connection broker through a web service interface, for example.

When a third party application requests a connection with a subscriber, the connection broker may check if the subscriber's specific terminal is reachable by the third party application. The subscriber's particular terminal may be available for contact with the connection broker, but may decline to be reachable by various third parties or third party applications, or the subscriber's specific terminal may be out of each of both the connection broker and the third party application.

The identity used by the third party application may be a full name, or any kind of unique identifier. The broker determines, based upon the preferences of the subscriber and the third party application, who will be charged, if anyone. For instance, the subscriber may be charged, the third party application may be charged, or the operator may provide the virtual connection for free. The subscriber may be involved in this negotiation, for instance, if explicit permission is needed. The actual charging may be based, for example, on a mobile network's postpaid or prepaid mechanism, or some other mechanisms such as a credit card. If this process of acquiring a connection fails because, for instance, the terminal is not reachable or charging a credit card is unsuccessful, then the broker sends an error message to the application.

If the connection acquisition phase succeeds, then the broker allows the third party application and the terminal to communicate. At this stage, the broker may act transparently, for example by providing the third party application with the valid address (e.g. IP address) of the terminal, and allowing a third party application outside of the mobile network to communicate directly. The other option is that the broker acts as an arbitrator, relaying all data between the peers, potentially doing conversion of protocols and data to facilitate the communication between the peers.

As mentioned, the communication between the peers may be one single transaction or a session consisting of any number of transactions. This “virtual connection” may be valid for some specific time, a specific amount of data, or a specific number of transactions agreed during the connection acquisition. Once this lease terminates, further communication initiated by peers from the outside network are not allowed, without a new acquisition. The system of the present invention is expandable, to make available the necessary APIs so that application developers will be able to use the services of the connection broker.

In short, the present claimed method is for setting up a communication session between a first peer inside a mobile network, and a second peer outside that mobile network. Contact is established from the second peer to a connection broker responsible for brokering various connections with the first peer, and the second peer requests from the connection broker a connection to the first peer. The connection broker determines whether the first peer is reachable, and finds out what costs, if any, would be borne by the first peer or the second peer or both, in order to pay for a lease of at least the connection requested by the second peer. Then, the communication session is set up via the connection, if the first peer is reachable and the costs are acceptable.

Likewise, the present invention also includes a system for setting up a communication session between peers. This system includes a first peer inside a mobile network, and a connection broker for brokering various connections with the first peer. The system also includes a second peer outside the mobile network, for establishing contact from the second peer to the connection broker, and for requesting from the connection broker a connection to the first peer. The connection broker is for determining reachability of the first peer, and is also for finding out costs, if any, that would be borne by the first peer or the second peer (or both) for a lease of the connection. The connection broker is furthermore for setting up the communication session via the connection if the first peer is reachable and the costs are acceptable.

The present invention additionally covers a mobile device, including a first peer, for setting up a communication session with a second peer. The mobile device includes a transceiver, for receiving and passing along a connection inquiry signal sent from a connection broker in order to determine reachability and cost requirements of the mobile device. The mobile device may also include a processing unit, responsive to the connection inquiry signal, for providing a preference query signal. A connection broker preference module is responsive to the preference query signal, and is for providing a preference reply signal indicative, for example, of the reachability and the cost requirements. The processing unit is responsive to the preference reply signal, by providing an availability and cost signal to the transceiver, and the transceiver transmits the availability and cost signal to the connection broker. Subsequently, the mobile device is able to communicate with a second peer via a connection signal, in conformity with the reachability requirements and the cost requirements.

### BRIEF DESCRIPTION OF THE DRAWINGS

FIG. 1 is a flow chart showing a method according to the present invention.

FIG. 2 depicts a system according to the present invention.

FIG. 3 shows a mobile device according to the present invention, in the form of a block diagram.

FIG. 4 is a block diagram showing the environment of a connection broker library.

### DETAILED DESCRIPTION OF THE INVENTION

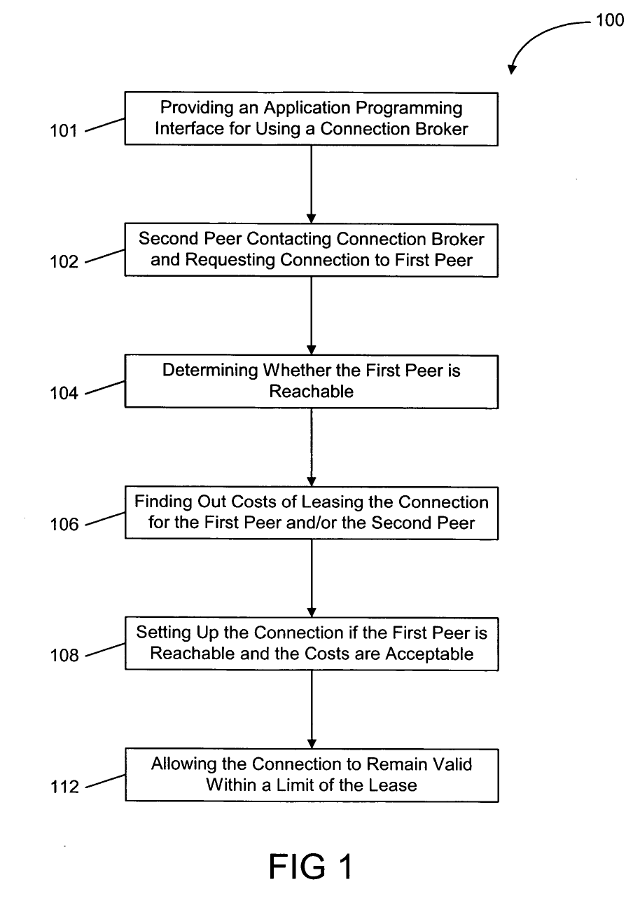

FIG. 1 facilitates a more detailed understanding of the present invention. This figure shows an exemplary method 100 for setting up a communication session between a first peer inside a mobile network, and a second peer outside that mobile network. The second peer seeks to participate in the communication session via internet, and the second peer is located in a fixed network.

This method begins by providing 101 an application programming interface (API) for an application, the API enabling utilization of a connection broker. Then, the second peer contacts 102 the connection broker. This connection broker is responsible for brokering various connections to the first peer by which the first peer automatically provides a web service or resource. The second peer requests from the connection broker a connection to the first peer. The connection broker acts here as a server with respect to an application of the second peer, and setting up the communication session is a service provided by the connection broker through, for instance, a web service interface.

A determination is made 104 whether the first peer is reachable. Also, the connection broker must find out costs 106, if any, that would be borne by the first peer or the second peer or both, for a lease of the connection. It may well be that none of the costs are to be borne by the first peer, and it is also possible that neither peer will bear any cost. In this embodiment, finding out costs is done by the connection broker in consultation with the first peer or the second peer or both, and the costs are considered by the connection broker to be acceptable if the first peer approves costs borne by the first peer and the second peer approves costs borne by the second peer. Optionally, these consultations may be based on a contract established earlier with either of the peers, so the consultation does not need to take place for every single lease.

Once any costs are indicated to be acceptable, then the communication session is set up 108 via the connection, if the first peer is reachable. Setting up the communication session is accomplished by providing an address of the first peer to the second peer, but alternatively the connection broker relays all data between the first peer and the second peer.

The connection is allowed to remain valid 112 within limits of the lease. That limit of the lease may be a time limit, or an amount of data, or a number of transactions. Enforcing the terms of the lease can be done easily if the connection broker relays all data between the peers, but it is also possible for the first peer to enforce the lease.

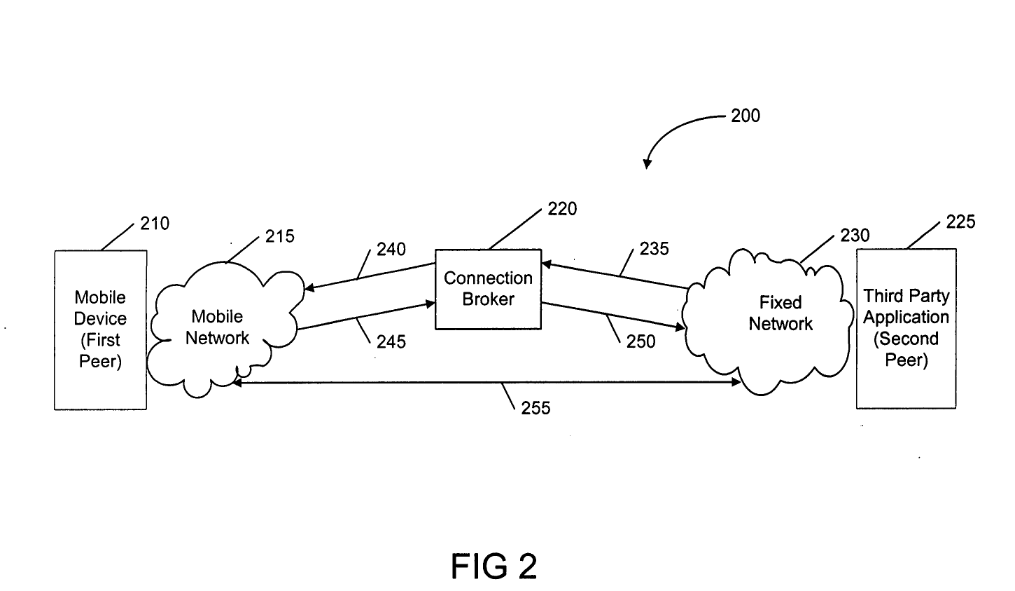

Turning now to FIG. 2, this shows an exemplary system 200 for carrying out the invention. A mobile device is the first peer 210, and it is connected to a mobile network 215, which in turn is connected to the connection broker 220. A third party application is the second peer 225, and it is connected to a fixed network 230 which may be part of the internet.

The second peer 225 sends a connection request signal 235 to the connection broker 220. In response, the connection broker 220 sends, for example, a connection inquiry signal to the first peer 210. Another option is that reachability of a device 210 is requested from the mobile network, rather than from the terminal itself. Alternatively, the connection broker 220 maintains a rule set regarding when a connection lease can be authorized in an autonomous manner, in contrast to requiring intervention by a first or second peer; the connection broker decides based on its rule set if the connection lease is satisfactory, so that the first or second peer will normally need to be consulted only as a fallback.

As shown in FIG. 2, the first peer replies by sending an availability and cost signal 245 to the connection broker, indicating the reachability of the first peer as well as any cost that the first peer might be willing to pay for that reachability. The first peer may base its decisions in this regard at least partly upon the identity of the second peer 225, which may be conveyed by the connection inquiry signal 240. In any event, the connection broker 220 sends a connection setup signal 250 to the second peer 225 telling the second peer how to proceed with the communication session between the two peers, assuming that the second peer wishes to pay its share of the costs.

The communication session may be conducted separately from the connection broker via the connection signal 255 (this may be called “transaction mode”). Alternatively, the connection broker can serve as intermediary (this may be called “arbitrator mode”).

Of course, the second peer, and also the connection broker will have to be equipped with software for implementing this method. The mechanism can be fully transparent from the first peer's perspective, except that the method may optionally support a mechanism to respond to the connection broker in case the first peer needs to be involved in handling of the connection request from the second peer. The required software may be a data structure embodied in a computer readable medium, for enabling the method to be performed.

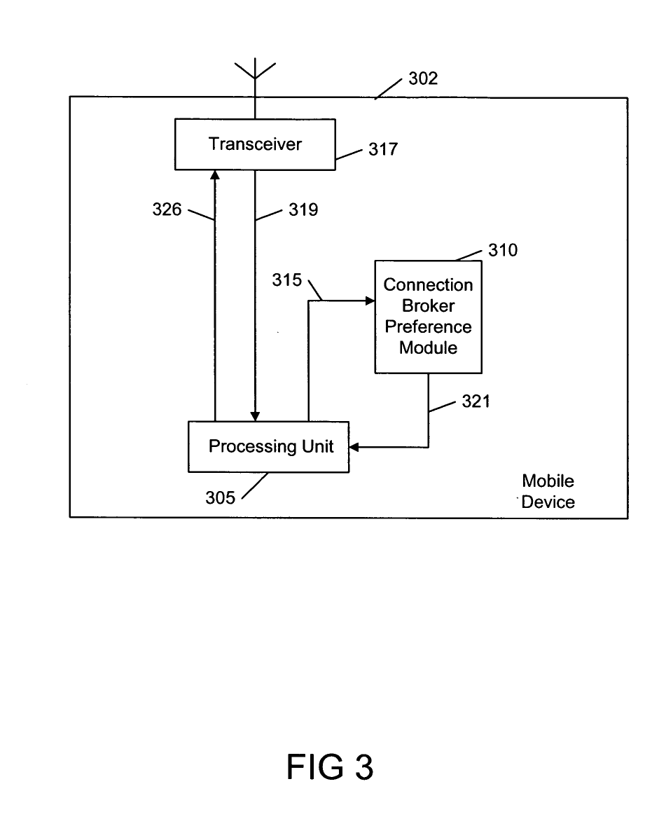

Turning now to FIG. 3, this is a block diagram of a mobile device 302 according to the present invention. The transceiver 317 receives the connection inquiry signal 319 and conveys it to a processing unit 305. The processing unit, which may be a central processing unit (CPU), then sends a preference query signal 315 to a connection broker preference module 310. Alternatively, this preference module may reside in the connection broker, or another simple option is that the inquiry signal is actually a WAP push message sent by the connection broker and presented to the user for selection. This module contains the user's preferences for dealing with the connection broker, and those preferences may include an indication when to actually prompt the user instead of proceeding automatically. In any event, the connection broker preference module 310 will then provide a preference reply signal 321 to the processing unit 305. The processing unit will then have the information it needs to prepare and send an availability and cost signal 326 to the transceiver 317 which will then convey that signal to the connection broker. Ultimately, of course, the transceiver may be used to support the connection itself, if the connection is finally established.

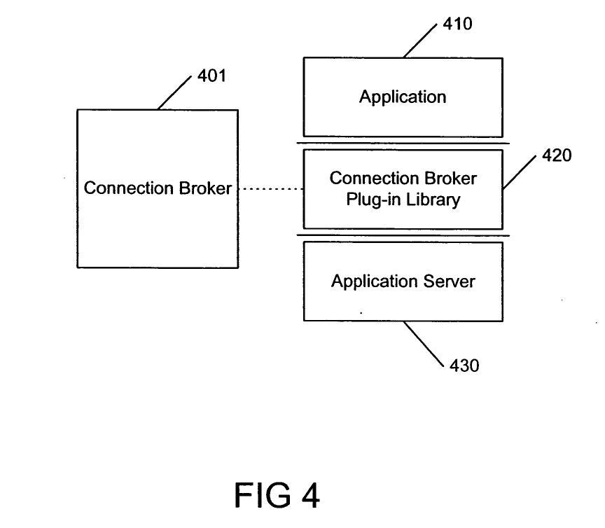

FIG. 4 simply illustrates the environment in which a plug-in library 420 can be used in conjunction with the present invention. This library makes available the necessary application programming interface (API) so that developers of an application 410 will be able to use the services of the connection broker 401 to acquire connections between peers. The API is provided by a standard application server 430.

It is to be understood that all of the present Figures, and the accompanying narrative discussions of the invention, do not purport to be completely rigorous treatments of the method and system under consideration. A person skilled in the art will understand that the steps and signals of the present application represent general cause-and-effect relationships that do not exclude intermediate interactions of various types, and will further understand that the various steps and structures described in this application can be implemented in a variety of different sequences, and by a variety of different combinations of hardware and software which need not be further detailed herein.

1. A method of setting up a communication session between a first peer inside a mobile network, and a second peer outside that mobile network, comprising:
establishing contact from the second peer to a connection broker responsible for brokering various connections with the first peer,
requesting from the connection broker a connection to the first peer,
determining whether the first peer is reachable,
finding out costs, if any, that would be borne by the first peer or the second peer or both, for a lease of at least the connection, and
setting up the communication session via the connection, if the first peer is reachable and the costs are acceptable.

2. The method of claim 1, wherein the connection broker acts as a server with respect to an application of the second peer.

3. The method of claim 1, wherein said setting up the communication session is a service provided by the connection broker through a web service interface, and wherein the various connections include a web service or resource automatically provided by the first peer.

4. The method of claim 1, wherein none of the costs are borne by the first peer.

5. The method of claim 1, wherein said at least the connection comprises a plurality of connections.

6. The method of claim 1, wherein the connection remains valid within at least one limit of the lease.

7. The method of claim 1, wherein the second peer participates in the communication session via internet, and wherein the second peer is located in a fixed network.

8. The method of claim 6, wherein said at least one limit of the lease comprises a time limit, or an amount of data, or a number of transactions.

9. The method of claim 1, wherein said setting up the communication session is accomplished by providing an address of the first peer to the second peer.

10. The method of claim 1, wherein said setting up the communication session is accomplished by the connection broker relaying all data between the first peer and the second peer.

11. The method of claim 4, wherein none of the costs are borne by the second peer.

12. The method of claim 1, wherein said finding out costs is done by the
connection broker in consultation with the first peer or the second peer or both, and
wherein the costs are acceptable if the first peer approves costs borne by the first peer and the second peer approves costs borne by the second peer.

13. The method of claim 2, preceded by making available at least one application programming interface for the application, the application programming interface enabling utilization of the connection broker.

14. A data structure embodied in a computer readable medium, for enabling the first peer, the second peer, or the connection broker to perform according to the method of claim 1.

15. A system for setting up a communication session between peers, comprising:
a first peer inside a mobile network;
a connection broker, for brokering various connections with the first peer;
a second peer outside the mobile network, for establishing contact from the second peer to the connection broker, and for requesting from the connection broker a connection to the first peer,
wherein the connection broker is for determining reachability of the first peer, and is also for finding out costs, if any, that would be borne by the first peer or the second peer or both for a lease of at least the connection, and
wherein the connection broker is furthermore for setting up the communication session via the connection if the first peer is reachable and the costs are acceptable.

16. The system of claim 15, wherein the connection broker is located in a fixed device or a mobile device.

17. The system of claim 15, wherein the connection broker acts as a server with respect to an application of the second peer.

18. The system of claim 15, wherein said setting up the communication session is a service provided by the connection broker through a web service interface, and wherein the various connections include a web service or resource automatically provided by the first peer.

19. The system of claim 15,
wherein the second peer is for establishing the contact and requesting the connection via a connection request signal from the second peer to the connection broker,
wherein the connection broker is responsive to the connection request signal, and is for determining said reachability and finding out said costs autonomously or by sending a connection inquiry signal to the first peer,
wherein the first peer is responsive to the connection inquiry signal, and is for providing an availability and cost signal to the connection broker, and
wherein the connection broker is responsive to the availability and cost signal, and is for accomplishing the setting up of the communication session by providing a connection setup signal to the second peer, the connection setup signal being indicative of how to proceed with the connection and indicative of the costs.

20. The system of claim 15, wherein the connection broker is for determining the reachability by asking the mobile network.

21. A mobile device including a first peer, for setting up a communication session with a second peer, comprising:
a transceiver, for receiving and passing along a connection inquiry signal sent from a connection broker in order to determine reachability and cost requirements of the mobile device;
a processing unit, responsive to the connection inquiry signal, for providing a preference query signal; and
a connection broker preference module, responsive to the preference query signal, for providing a preference reply signal indicative of the reachability and the cost requirements,
wherein the processing unit is also responsive to the preference reply signal, and is also for providing an availability and cost signal to the transceiver, and
wherein the transceiver is also for transmitting the availability and cost signal to the connection broker, and for subsequently communicating with a second peer via a connection signal in conformity with the reachability and cost requirements.
